(19) United States
(12) Patent Application Publication
(10) Pub. No.: US 2014/0257831 A1
(43) Pub. Date: Sep. 11, 2014

(54) Method And Apparatus For Generating Proxy Eligibility Data

(71) Applicant: MCKESSON FINANCIAL HOLDINGS, Hamilton (BM)

(72) Inventor: Jonathan M. Niloff, West Newton, MA (US)

(73) Assignee: MCKESSON FINANCIAL HOLDINGS, Hamilton (BM)

(21) Appl. No.: 13/792,688

(22) Filed: Mar. 11, 2013

(51) Int. Cl. G06F 19/00

(52) U.S. Cl. CPC G06F 19/328
USPC 705/2

(57) ABSTRACT

A method, apparatus, and computer program product are described herein for generating proxy eligibility data. Input data may be received, such as claim data from a health plan and/or provider organization, or attributed patient lists including patient identifiers of patients currently eligible for coverage in an Accountable Care Organization (ACO). Patient eligibility data may be determined based on the input data, and may be used in generating cost, quality, and/or utilization, metrics, and assessing risk for provider organizations.

### TECHNOLOGICAL FIELD

Various embodiments of the invention are related to generating proxy eligibility data and particularly to determining patient eligibility for coverage by a payer, such as a health plan or other form of healthcare insurance.

### BACKGROUND

The evolving healthcare model is transferring the financial risk for patient care from health plans to healthcare providers. Changes in contract models to adopt accountable care practices are increasing, transferring an increasing amount of risk from healthcare insurers to healthcare providers.

Additionally, an increasing number of provider organizations are participating in the Center for Medicaid and Medicare Service's (CMS) Accountable Care Organizations (ACO). The goal of an ACO is to provide high-quality care while minimizing the cost of healthcare for a group of participants as a whole. An ACO may participate in a Shared Savings Plan (SSP), which facilitates coordination and consistency in healthcare amongst participating providers in the ACO. The result of an effectively operating SSP may include improved quality of healthcare and longterm savings for CMS due to improved preventive care, patient and provider education, and a better understanding of financial risk to the provider.

However, it may be difficult for a healthcare provider to understand and manage their risk population because the healthcare provider may not have access to information that clearly defines their risk patient population. Patient populations may change as frequently as daily, as patients make changes in their healthcare coverage. The healthcare provider may not always be notified of such changes, nor have access to such information, such as premium payment information by an employer, or patient enrollment in a health plan or for coverage by another type of payer.

### BRIEF SUMMARY

Embodiments of the present invention, among other things, address the above-referenced problem by providing healthcare providers with a tool for generating proxy eligibility data. As such, inputs such as claim data, and/or attributed beneficiary lists may be processed according to the processes described herein, and proxy eligibility data may be imputed, providing an estimate of a particular patient population for a given time period.

A method, apparatus, and computer program product are therefore provided for generating proxy eligibility data. More specifically, the example embodiments of the system described herein provide for determining patient eligibility in a health plan by receiving input data such as claim data from a health plan and/or provider organization, or attributed patient beneficiary lists including patient identifiers of patients currently eligible for coverage in a CMS SSP ACO. The system, in some examples, may be particularly beneficial to provider organizations in understanding their financial risk by providing more accurate calculations based on an eligible population, and therefore providing for more accurate population-based rates, such as per member per month costs, or annual rates per 1000 members.

A method is provided, including receiving input data comprising at least one of: a) claim data, or b) an attributed patient list, and generating proxy eligibility data based on the input data, wherein the proxy eligibility data comprises eligibility data by patient. In some embodiments, the proxy eligibility data comprises a patient identifier, an indication of a product, and a plurality of binary eligibility flags. In some embodiments, generating the proxy eligibility data further comprises for a patient, determining a value for at least one of the plurality of binary eligibility flags, wherein respective binary eligibility flags are associated with a predefined period of time, receiving interim input data, and updating the value of at least one binary eligibility flag retrospectively, based on the interim input data.

In some embodiments, generating proxy eligibility data further comprises: determining an eligibility start date for a patient based on the input data, generating a proxy eligibility file comprising the eligibility start date, and generating the proxy eligibility data based on the proxy eligibility file, wherein the proxy eligibility data is in a format compatible with a risk management application. The proxy eligibility data may be generated without the use of payer-provided eligibility data.

In some embodiments, generating proxy eligibility data further comprises determining an eligibility start date for a patient based on the input data, and generating the proxy eligibility data based on the eligibility start date. In some embodiments, generating proxy eligibility data further comprises determining an eligibility end date for the patient, and generating the proxy eligibility data based on the eligibility end date.

In some embodiments, determining the eligibility end date further comprises identifying a change in a product for a patient and an associated change date based on the input data, and determining the eligibility end date based on the associated change date.

In some embodiments, the method further includes receiving additional input data, and retrospectively updating the proxy eligibility data based on the additional input data. The method may further include calculating an eligible population based rate, based on the proxy eligibility data, wherein the eligible population based rate is used for calculating one or more metrics related to at least one of cost, utilization, or quality. In some embodiments, the method includes calculating a fee associated with a claim, and calculating an eligible population based rate based on at least the calculated fee and the proxy eligibility data. Receiving input data may comprise receiving outbound claim information from a provider organization. In some embodiments, receiving input data further comprises receiving claim information for in-network services from a payer.

The method may include receiving pre-filtering criteria, and identifying a subset of the input data based on the pre-filtering criteria, wherein the proxy eligibility data is generated based on the subset of the input data. The input data may comprise at least one attributed patient list for an Accountable Care Organization.

An apparatus is provided, comprising at least one processor and at least one memory including computer program code, the at least one memory and the computer program code configured to, with the processor, cause the apparatus to at least receive input data comprising at least one of: a) claim data, or b) an attributed patient list, and generate proxy eligibility data based on the input data, wherein the proxy eligibility data comprises eligibility data by patient.

A computer program product comprising at least one non-transitory computer-readable storage medium having computer-executable program code instructions stored therein, the computer-executable program code instructions comprising program code instructions to receive input data comprising at least one of: a) claim data, or b) an attributed patient list, and generate proxy eligibility data based on the input data, wherein the proxy eligibility data comprises eligibility data by patient.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of a system for generating proxy eligibility data according to an example embodiment;

FIG. 2 is a block diagram of a patient eligibility apparatus according to an example embodiment;

FIG. 3 is a flowchart illustrating operations for generating proxy eligibility data;

FIG. 4 is a flowchart illustrating operations for generating proxy eligibility data based on received claim data; and

FIG. 5 is a flowchart illustrating operations for generating proxy eligibility data based on received attributed beneficiary lists.

### DETAILED DESCRIPTION

Some embodiments will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As described above, an evolving healthcare model is transferring the financial risk for patient care to healthcare providers. To manage this financial risk, provider organizations need software solutions to help them understand the cost of care and manage that care accordingly. These software solutions must be able to accurately calculate key cost and utilization metrics (e.g. per member per month costs, annual rates/1,000 members). Such analytic tools and their embedded calculations use claims data. However, a precise definition of the population subject to the risk arrangement may be required to calculate the key metrics required for population management. Payers and providers have historically performed such calculations based on member eligibility files, which provide a reliable definition of an eligible patient population for a given time period. Some scenarios have emerged that prohibit provider organizations from using analytic tools and performing the same calculations because the payers (with which they have risk arrangements) do not provide them with the needed eligibility files.

Some provider organizations, such as those managing Preferred Provider Organization (PPO) and/or Fee For Service (FFS) patient populations do not receive eligibility files from the respective payers. A payer, such as a health plan, or health insurer, may retain and manage patient eligibility information. A “payer” may be considered any entity responsible for making a payment for healthcare on the behalf of a patient, such as a health plan or health insurer. Some common payers include health insurers that offer PPO or FFS products. For simplicity these organizations may be referred to hereinafter as PPOs, but may also or otherwise include organizations that offer FFS products. A payer may also include government regulated organizations such as CMS.

A “provider organization,” “healthcare provider,” or “provider” may be considered any entity who offers care to a patient. The provider organization may receive payment from the patient and/or payer. A provider organization, in some instances, may collect claim data related to an office visit that resulted in an outbound claim to the payer, but may have no other knowledge of an eligible population until the need for services arises. In some instances, claim records for in-network care may be transmitted from the payer to the provider organization. “Claim data” may therefore be considered information relating to a claim for payment of services for an eligible patient, as captured by a payer or provider organization.

Similarly, provider organizations that are ACOs participating in a CMS SSP may not have access to complete patient “eligibility data,” or data defining a patient population eligible for a particular health plan for a given time period. Rather, CMS may send the provider organization patient lists periodically. An “attributed beneficiary list,” or “attributed patient list” may include patient data such as a patient name, gender, date of birth, and a unique identifier, but the format may be limited and may not specify precise eligibility start and end dates for a patient. A patient included on the attributed beneficiary list may instead be considered an eligible patient for a particular time period associated with the attributed beneficiary list, as of the day an attributed beneficiary list is generated or transmitted to a provider, or the last day of the prior calendar month, for example.

Embodiments of the present invention may therefore provide healthcare providers with a better understanding of eligible patient populations and associated risks by generating proxy eligibility data based on claims data in the case of PPO populations, and/or from the attributed beneficiary lists in the case of SSP populations. “Proxy eligibility data” may be considered information describing a population eligible for coverage by a payer, and may comprise a representation by month of which plan or product a patient is eligible for coverage, such as by a binary eligibility flag for each month. The proxy eligibility data may be in a format that is compatible with a risk management application to allow for population-based risk calculations and more accurate reporting from the risk management tool. Providers may therefore more effectively manage their at-risk patient population and improve performance of their organization. Improved understanding of the risk population may lead to improvements in resource allocation, identification of gaps in service, identification of high-risk populations, and a better understanding of the value of preventive care, for example.

Generation of proxy eligibility data may occur via different processes for PPOs and SSP organizations, as a PPO population may be structured differently than an ACO, and the provider-payer contracts may differ depending on the payer type. The result, however, may be similar in that the proxy eligibility data provides a description of an eligible patient population for either type of organization. In some embodiments, a “proxy eligibility file” may be generated as an intermediary file used to generate the proxy eligibility data, and may comprise estimated eligibility start dates, end dates, and/or binary monthly eligibility flags. A proxy eligibility file may be generated one time and/or may be refreshed and/or replaced by a newly generated proxy eligibility file each time new data becomes available. A proxy eligibility file may subsequently be used to generate the proxy eligibility data, in a format required by a risk management application. It will be appreciated that example embodiments described herein refer to making updates to proxy eligibility data and proxy eligibility files. In some embodiments, an update may apply to both the proxy eligibility data and proxy eligibility file. In some embodiments, an update may be made directly to the proxy eligibly data. In some embodiments, an update may initially be made to a proxy eligibility file, and later reflected in the proxy eligibility data.

Embodiments of the claimed invention utilize the logic and/or algorithms described in further detail herein to assign to a patient an eligibility start date and eligibility end date, and to serially over time, as new data is provided, adjust and correct the eligibility start and end dates. Retrospective adjustments may also be made upon receipt of additional data.

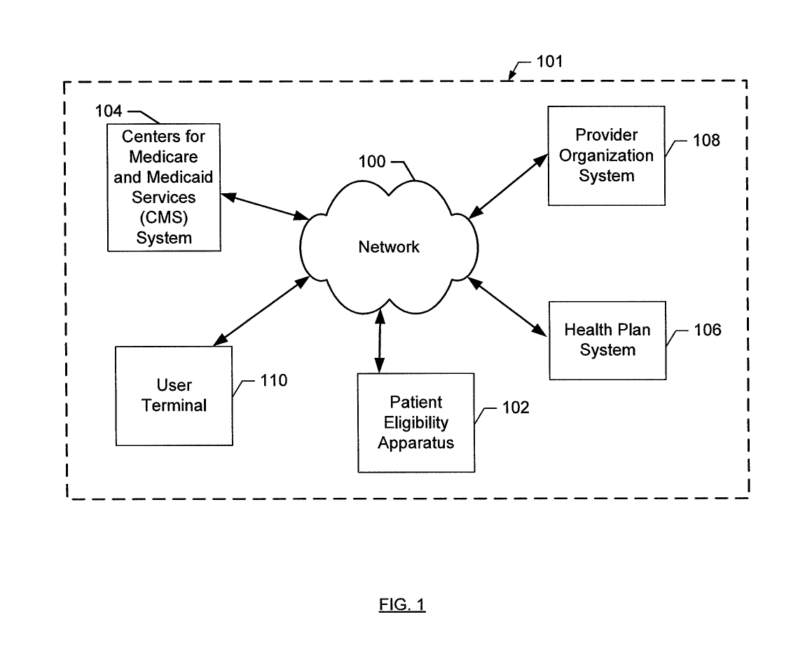

FIG. 1 is a block diagram of a system for generating proxy eligibility data according to an example embodiment. It will be appreciated that the system 101 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for generating proxy eligibility data, numerous other configurations may also be used to implement embodiments of the present invention.

The system 101 may include a patient eligibility apparatus 102 that may be configured to generate proxy eligibility data as introduced above and described in further detail hereinafter. The patient eligibility apparatus 102 may communicate with third party systems such as the CMS system 104, one or more health plan system(s) 106, and one or more provider organization system(s) 108, among others. Additionally or alternatively, a user terminal 110 may communicate with patient eligibility apparatus 102, particularly to access generated proxy eligibility data, as described herein.

The CMS system 104 may be any system, server, server cluster, apparatus, database and/or the like configured to provide data to authorized parties, regarding ACO SSPs, including the ACOs' “beneficiaries,” or participating members or patients. As such, the CMS system 104 may provide the patient eligibility apparatus 102 with attributed beneficiary lists used to generate proxy eligibility data for ACO populations, as described in further detail hereinafter.

The health plan system 106 may be any system, server, server cluster, apparatus, database and/or the like configured to provide data to authorized parties, regarding paid claims from in-network healthcare providers. In other words, following receipt of a claim from a provider for services, the health plan system 106 may provide the claim data to the patient eligibility apparatus 102 so that the claim data may be used to generate proxy eligibility data for PPOs.

The provider organization system 108 may be any system, server, server cluster, apparatus, database and/or the like configured to provide data to authorized parties, regarding outbound and/or paid claims for services provided to patients, presumably eligible for a specific insurance product offered by a PPO. The provider organization system 108 may therefore provide claim data to the patient eligibility apparatus 102 for use in generating proxy eligibility data for PPOs. In some embodiments, the claim data may be transmitted directly to the patient eligibly apparatus 102 for automatic processing by the patient eligibility apparatus 102. In some embodiments, the claim data may be received by a user having access to the patient eligibility apparatus 102, who may subsequently upload the claim data to the patient eligibility apparatus for processing.

Continuing with FIG. 1, system 101 may additionally and optionally comprise any number of user terminals 110, which may, for example, be embodied as a laptop computer, tablet computer, mobile phone, desktop computer, workstation, or other like computing device. A user terminal 110 may be remote from the patient eligibility apparatus 102, and/or third party systems of system 101, in which case the user terminal 110 may communicate with any of the respective apparatuses via network 100. Additionally or alternatively, the user terminal 110 may be implemented on patient eligibility apparatus 102.

The patient eligibility apparatus 102 may communicate with any of the above-described third party systems and/or user terminal 110 via any of a variety of methods dependent upon the configuration of the system 101. For example, in embodiments in which a patient eligibility apparatus 102 is disposed remotely from any of the third party systems, information such as attributed beneficiary lists and claim data may be provided to the patient eligibility apparatus 102 via a network 100, by a variety of connections. Network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, wireless wide area network, some combination thereof, or the like), or a combination thereof, and in some example embodiments comprises at least a portion of the Internet. As another example, a patient eligibility apparatus 102 may be directly coupled to any of CMS system 104, health plan system 106 and/or provider organization system 108.

In some example embodiments, patient eligibility apparatus 102 may be embodied as or comprise one or more computing devices, such as, by way of non-limiting example, a server, configured to access network 100. In some example embodiments, patient eligibility apparatus 102 may be implemented as a distributed system or a cloud based entity that may be implemented within network 100. In this regard, patient eligibility apparatus 102 may comprise one or more servers, a server cluster, one or more network nodes, a cloud computing infrastructure, some combination thereof, or the like.

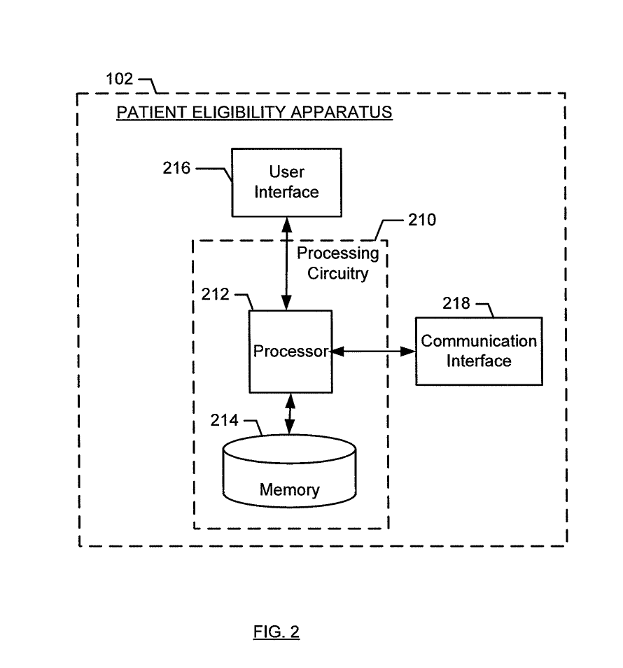

An example embodiment of a patient eligibility apparatus 102 is illustrated in FIG. 2. It should be noted that the components, devices, and elements illustrated in and described with respect to FIG. 2 below may not be mandatory and thus some may be omitted in certain embodiments. Additionally, some embodiments may include further or different components, devices, or elements beyond those illustrated in and described with respect to FIG. 2.

A patient eligibility apparatus 102 may include processing circuitry 210, which may be configured to perform actions in accordance with one or more example embodiments disclosed herein. In this regard, the processing circuitry 210 may be configured to perform and/or control performance of one or more functionalities of the patient eligibility apparatus 102 in accordance with various example embodiments. The processing circuitry 210 may be configured to perform data processing, application execution, and/or other processing and management services according to one or more example embodiments. In some embodiments, the patient eligibility apparatus 102 or a portion(s) or component(s) thereof, such as the processing circuitry 210, may be embodied as or comprise a circuit chip. The circuit chip may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216 and/or a communication interface 218. As such, the processing circuitry 210 may be embodied as a circuit chip (e.g., an integrated circuit chip) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of patient eligibility apparatus 102 as described herein. The plurality of processors may be embodied on a single computing device or distributed across a plurality of computing devices collectively configured to function as the patient eligibility apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the patient eligibility apparatus 102. The memory 214 may be configured to store information, data, applications, instructions and/or the like for enabling the patient eligibility apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 216, and/or communication interface 218, for passing information among components of patient eligibility apparatus 102.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of proxy eligibility data generation operations and/or the like. In some example embodiments in which the patient eligibility apparatus 102 is embodied as a server, cloud computing system, or the like, aspects of user interface 216 may be limited or the user interface 216 may not be present. In some example embodiments, one or more aspects of the user interface 216 may be implemented on a user terminal 110. Accordingly, regardless of implementation, the user interface 216 may provide input and output means to facilitate generation of proxy eligibility data in accordance with one or more example embodiments.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable patient eligibility apparatus 102 to communicate with various systems over network 100. Accordingly, the communication interface 218 may, for example, include supporting hardware and/or software for enabling communications via cable, digital subscriber line (DSL), universal serial bus (USB), Ethernet, or other methods.

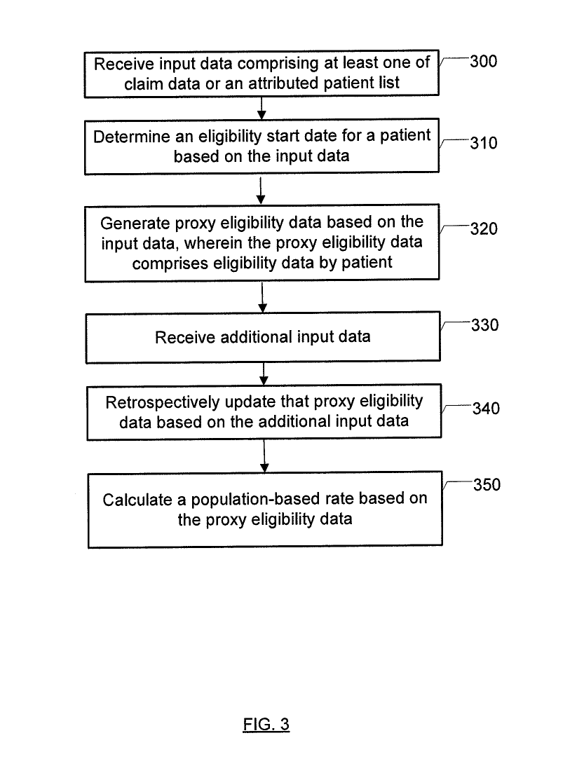

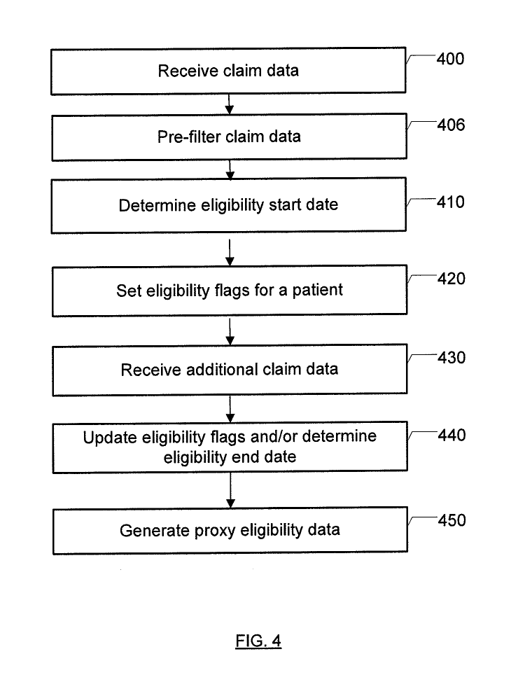

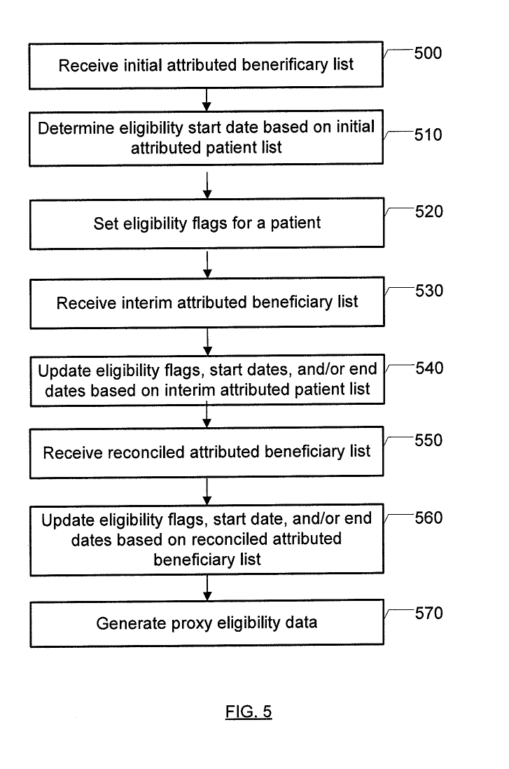

FIG. 3 is a flowchart illustrating operations for generating proxy eligibility data. As shown by operation 300, the patient eligibility apparatus 102 may include means, such as communication interface 218, for receiving input data comprising at least one of claim data or an attributed patient list. The claim data and/or attributed patient list may be received over network 100 from a third party system, either directly or indirectly by transmittal of an electronic file and subsequent uploading to the patient eligibility apparatus 102. The receipt of input data is described in further detail with respect to FIGS. 4 and 5.

At operation 310, the patient eligibility apparatus 102 may include means, such as processing circuitry 210 and/or processor 212 to determine an eligibility start date for a patient based on the input data. An eligibility start date may be estimated, for example, by setting the eligibility start date to the first of a month for which services were provided, based on claim data. Additionally or alternatively, an eligibility start date may be determined based on the first appearance of a patient on an attributed patient list. The eligibility start date may be stored and associated to a patient and/or product on memory 214, for example, such as by writing the eligibility start date to a proxy eligibility file, and associating the date with a patient and product type.

At operation 320, the patient eligibility apparatus 102 may include means, such as processing circuitry 210 and/or processor 212 for generating proxy eligibility data based on the input data, wherein the proxy eligibility data comprises eligibility data by patient. In some embodiments, the proxy eligibility data may comprise a unique patient identifier, associated health plan product (or indication of coverage type by a payer), and an eligibility flag for each month of a calendar year, indicating whether or not the particular patient is eligible for the coverage during a specific month. In other words, proxy eligibility data may comprise up to 12 eligibility flags per patient, per calendar year represented by the proxy eligibility data. In some embodiments, the eligibility flags may be determined based on the eligibility start date determined in operation 310. Additionally or alternatively, the proxy eligibility data may be imputed from a proxy eligibility file.

At operation 330, the patient eligibility apparatus 102 may include means, such as communication interface 218, for receiving additional input. The additional input data may be in the same format as input data receipted in operation 300, and/or it may be in a different format. The patient eligibility apparatus 102 may therefore process the input data similarly to or the same as in operations 310 and 320. The proxy eligibility data may therefore be updated, by replacement with new proxy eligibility data, or updates to the existing proxy eligibility data generated in operation 320. Additionally or alternatively, a proxy eligibility file may be updated, and the updates subsequently pushed to the proxy eligibility data. As discussed in more detail below, with respect to FIGS. 4 and 5, updates may include, for example, updating a patient's start date, and/or adding/updating a patient's end date, among others.

Continuing to operation 350, the patient eligibility apparatus 102 may include means, such as processing circuitry 210 and/or processor 212 for calculating an eligible population based rate based on the proxy eligibility data. That is, having determined a likely eligible patient population by operations 300-340, the patient eligibility apparatus 102 (or another system or apparatus) may utilize the proxy eligibility data to calculate more accurate rates per population, and therefore provide a better understanding of a provider's risk and performance. For example, an eligible population based rate for a diagnostic cost group and/or a utilization rate, such as emergency room visits per 1000 patients, may be calculated using proxy eligibility data. The proxy eligibility data may be used, for example, to determine a number of eligible member-months in a given time period for a particular population (e.g., 100 patients eligible for an entire calendar year may result in 120 member months, or 100×12). The patient eligibility apparatus 102 may additionally or alternatively retrieve a cost incurred to the provider for that same population over the same period of time to arrive at a rate per member per months. Additionally or alternatively, the proxy eligibility data may be transmitted from the patient eligibility apparatus 102, and may be used subsequently by various third party systems, such as or in addition to a risk management tool, for example, to better assess a population-based risk or cost. As such, systems utilizing the proxy eligibility data may generate a more accurate risk analysis for a given healthcare provider.

FIG. 4 is a flowchart illustrating operations for generating proxy eligibility data based on received claim data. In some embodiments, the patient eligibility apparatus 102 may operate based on the assumption that a patient may be eligible for a PPO/FFS product or an HMO product, but not both simultaneously, and that eligibility may change only on a monthly basis. In other words, a patient may be eligible for only one product in any month. By default, in some embodiments, eligibility may commence on January 1 of a calendar year and end on December 31 of a calendar year during which a patient is eligible based on a claim. In embodiments where claim data shows a patient has a claim with a date of service during a particular calendar year, that patient will be eligible for that entire calendar year. In some embodiments, the patient eligibility apparatus 102 may determine a patient is eligible for a health plan product for an entire calendar year. Partial eligible years for a patient may be permitted when the patient changes products during a calendar year as evidenced by claims for different products with service dates during the same calendar year or an eligibility file and/or data that defines eligibility for a product different than the product(s) reflected on a claim or claims with service date(s) for products to proxy eligibility during the same calendar year.

In some embodiments, the patient eligibility apparatus 102 may set an eligibility flag to indicate whether or not a particular patient is eligible for a product for each month. The flag may therefore be considered binary (yes/no) for a product for each month. The flags for each patient in the eligibility table are the basis for eligibility-based reporting (e.g. days/1000, pmpm-per member per month).

Proxy eligibility may be defined for each patient based on paid or adjudicated claims data and, following receipt of additional claim data, the eligibility data may be updated accordingly. With each data refresh, for a PPO patient that meets the inclusion criteria (described in further detail with respect to operation 406), the member's eligibility flag will be set to yes in the proxy eligibility data for the appropriate months.

At operation 400, the patient eligibility apparatus 102 may receive claim data, via communication interface 218, for example, and over network 100. The claim data may be provided by, in some example embodiments, a provider organization system 108 and/or a health plan system 106. The provider organization system 108 may produce outbound claim information comprising claims made on behalf of patients receiving service from the provider. The health plan system 106 may produce inbound claim information comprising claims received from a provider organization for services provided to a patient. Regardless of the source of the claim data, the patient eligibility apparatus 102 may process the claim data, which may include a patient identifier (such as a patient number provided by the health plan), a date of service, service description, cost of service, and a covered cost and/or covered portion.

As shown by operation 406, the patient eligibility apparatus 102 may pre-filter the claim data in preparation for processing. In some embodiments, such as those in which claim data is received from a provider organization, a configurable filtering algorithm may limit the patients that are subjected to being assigned a proxy eligibility to those patients that are most likely to obtain their longitudinal care from the provider organization, based on the algorithm configurations. The goal may be to limit the evaluated patient population to that which is relevant to the provider organization by excluding patients who only received episodic care. For example, if claim data provides evidence of an emergency room visit only (such as for an arm fracture), the patient may be excluded from consideration of eligibility based on an assumption that the patient received his/her primary and longitudinal care elsewhere. As such, in some embodiments, only relevant or requested data may be considered for processing. Such a feature may provide improved configurability of risk management tools for provider organizations, particularly those with complex patient populations. The configurations defining the pre-filtering may additionally be referred to as inclusion criteria.

Based on the claim data, at operation 410, the patient eligibility apparatus 102 may determine an eligibility start date for the patient associated with the claim data. A patient's initial PPO eligibility may commence on January 1 of the first year in which the patient meets the inclusion criteria and has a claim for a product configured as eligible for proxy eligibility with a service date in that year. January 1 of that year may therefore be defined as the “eligibility start date.” An eligibility start date may be stored temporarily in memory 214, for example, or written directly to a proxy eligibility file, which also may be stored on memory 214.

Continuing to operation 420, the patient eligibility apparatus 102, by use of processing circuitry 210 and/or processor 212, for example, may set eligibility flags for a patient. The flags may be stored temporarily in memory 214, written to a proxy eligibility file, and/or directly updated in the proxy eligibility data. As such, the patient's eligibility flag in the proxy eligibility data and/or file may be set to yes beginning on the eligibility start date. Eligibility may continue indefinitely thereafter until an end date is determined. Said differently, the patient eligibility apparatus 102 may set eligibility flags to yes for the month of January and each month thereafter until an end date for that product is determined, as described below.

At operation 430, the patient eligibility apparatus 102 may receive additional claim data, which may be used to update and/or refresh a proxy eligibility file and/or associated proxy eligibility data. Claim data may be received via communication interface 218 on an ongoing basis, as it becomes available, for example, or by a routine schedule, such as monthly. At operation 440, the claim data may therefore be processed, and start dates, end dates, and eligibility flags updated accordingly in respective proxy eligibility files and/or associated data.

In some embodiments, the eligibility period end date may be configurable. As such, if a member has not had a claim for a full calendar year, the end date may be set to December 31 of the prior year (the last year in which the member had a claim with a service date in that year), or the last day of the measurement period. In this case, months subsequent to the end date will have their eligibility flags reset to no.

In some embodiments, lag may be considered when making this determination. Lag is the method used to mitigate the delays in the submission of claims to payers by provider organizations, delays in the payers paying the claims, and/or delays in receipt of the claim data by the patient eligibility apparatus 102. In other words, it may take weeks to months past the last day of a measurement period to receive all claim data with dates of service in the measurement period. For maximum accuracy, it is desirable to have all the claims with dates of service in the relevant time period (the time period for which the proxy eligibility is being determined). Lag is the period of time after the last service date for the evaluation period that the apparatus 102 may be configured to wait before assigning the final eligibility. For example, in determining eligibility for a given measurement period that is a calendar year, the input is all claims with dates of service in the calendar year. The patient eligibility apparatus 102 may be configured to consider 2 months of lag time, so that claims with paid dates through February 28^{th} of the following calendar year would be processed prior to identifying an eligibility end date and/or setting eligibility flags to no. Without consideration of lag, some eligibility end dates may be erroneously set, and/or eligibility flags erroneously set to no.

Additionally or alternatively, eligibility may change based on changes to different products. If a member switches from one FFS/PPO product to another FFS/PPO product (based on the product listed on their claims), the member's eligibility may be updated to reflect this change, as follows. If the patient has claims for two products in the same calendar year, the month of the last service date on a claim for the first product may be that product's end date and the following month may be the start date for the new product. The eligibility flags may be set to yes for all months, but the product populated in the proxy eligibility data will be set based on the end and start dates for the respective products, as described above.

In some embodiments, if there are claims for two products, (for example, products A and B) in different calendar years, then the patient eligibility apparatus 102 may set the end date for product A to December 31 of the last year in which the patient had a claim with a service date for that product A and the start date for the next product B may be set to January 1 of the next year, or the first year in which there is a claim with a service date for the product B.

It will be appreciated that operations 430 and 440 may be repeated as additional claim data is received. As such, the patient eligibility apparatus 102 may provide up to date and accurate proxy eligibility data and/or updates to the proxy eligibility file.

At operation 450, the patient eligibility apparatus may generate proxy eligibility data, based on any of the eligibility start dates, eligibility end dates, and/or eligibility flags, which may be stored in a proxy eligibility file as described above. Additionally or alternatively, the proxy eligibility data may be generated in conjunction with operations 400-440, and updated on an ongoing basis. In some embodiments, the start dates, end dates, and/or flags may be stored as temporary data on memory 214 (such as in a proxy eligibility file), from which the proxy eligibility data may be generated from, on demand. A proxy eligibility file may then be transmitted to a third party such as a provider organization system 108. In some embodiments, the proxy eligibility file may be transmitted to a user terminal 110, upon request and with appropriate permissions.

As described above and with respect to FIG. 4, the patient eligibility apparatus 102 may generate, and retrospectively update, proxy eligibility data based on claim data received from a third party, such as provider organization system 108 and/or health plan system 106. The proxy eligibility file may be used accordingly to better calculate risk for a particular provider, such as described with respect to FIG. 3 above. As such, the population defined by a proxy eligibility file may represent a bottom denominator in a risk calculation. In some embodiments, the patient eligibility apparatus 102 may calculate a fee associated with a claim, in order to additionally calculate the cost of services for the particular population, or numerator in the risk calculation.

Additionally or alternatively, according to some embodiments, attributed patient lists, such as those provided by CMS, may be used by the patient eligibility apparatus 102 to generate proxy eligibility data. This process is illustrated by the flowchart of FIG. 5.

FIG. 5 is a flowchart illustrating operations for generating proxy eligibility data based on a received attributed patient list. In generating proxy eligibility data from an attributed patient list, the patient eligibility apparatus 102 may determine eligibility for a measurement period, such as a calendar year. In some embodiments, the first measurement period may not necessarily be a complete year, depending on the date an ACO begins to be accountable for the care of their at risk population, and may therefore fall short of a full calendar year. It will be appreciated that although example embodiments described herein refer to a measurement period of a calendar year, and binary eligibility flags per month, various other measurement periods and/or terms for the binary eligibility flags may exist. Patient eligibility for a measurement period may be binary (eligible or not), and may be updated with each attributed beneficiary list received. In some embodiments, a final eligibility may be determined in retrospect based on a final reconciliation attributed beneficiary list. Final eligible months after reconciliation (assuming a 12 month measurement period) may be 0 or 12, based on whether the patient is present on the final reconciliation attributed beneficiary list. During a measurement period, or subsequent to that measurement period but prior to processing of the final reconciliation attributed beneficiary list for that measurement period, the patient will be eligible (and the eligibility flag will be set to yes) for each month during the measurement period that claims data has been processed. These interim eligible months, may be subsequently reconciled (and the eligibility flag set to no) based on subsequent interim attributed beneficiary lists or reconciled attributed beneficiary list. A “reconciled attributed beneficiary list” may be considered an attributed beneficiary list indicating eligible patients at the conclusion of a measurement period. An “interim attributed beneficiary list” may be considered an attributed beneficiary list indicating eligible patients at a specific point in time during a measurement period.

As shown by operation 500 of FIG. 5, the patient eligibility apparatus 102 may include means, such as communication interface 218, for receiving an initial attributed beneficiary list, from CMS system 104 and over network 110, for example. An initial attributed beneficiary list may be considered the first of interim beneficiary lists. In some embodiments, an attributed beneficiary list may be transmitted directly to the patient eligibly apparatus 102 for automatic processing by the patient eligibility apparatus 102. In some embodiments, an attributed beneficiary list may be received by a user having access to the patient eligibility apparatus 102, who may subsequently upload the attributed beneficiary list to the patient eligibility apparatus 102 for processing. The methods of receipt of an attributed beneficiary list may apply to subsequent (e.g., interim, and/or reconciled) reconciled beneficiary lists.

At operation 510, the patient eligibility apparatus 102 may determine an eligibility start date based on the attributed patient list. Patients on the initial (first) attributed patient list will each have their eligibility start date set to the ACO start date. In some embodiments, the provider organization may provide their ACO start date.

In some embodiments, once a patient is made eligible in the system with a start date, as described above, they will be continuously eligible until an end date is determined for that patient, as described in further detail below. At operation 520, the patient eligibility apparatus 102 may set eligibility flags for a patient who appears on the attributed patient list. In some embodiments, a flag may be defaulted to yes for the duration of the calendar year of the ACO start date.

At operation 530, patient eligibility apparatus 102 may include means, such as communication interface 218, for receiving an interim attributed patient list. For example, in some embodiments, an interim attributed patient list may be sent quarterly by CMS, or in some other repeated increment, and may include updated patient eligibility, compared to the most recently received attributed patient list. As shown by operation 540, the patient eligibility apparatus 102 may update eligibility flags, start dates, and/or end dates based on the interim attributed patient list as follows. Patients on the interim attributed patient list that are currently eligible (based on the initial or a prior quarterly or final reconciliation list) may remain eligible, and eligibility for all months from the eligibility start to the last date for which claims data is available for reporting may be set to yes, until an eligibility end date is established for the patient.

For patients on the interim list but not currently eligible in the proxy eligibility file, the patient eligibility apparatus 102 may assign a start date, as follows. If the interim list is designated for or received in the first measurement year, the start date may be the ACO start date. If the interim list is for a subsequent measurement year, the start date will be the start date for that subsequent measurement year (e.g., January 1).

In some embodiments, once a patient is made eligible in the system with a start date, they will be continuously eligible (eligibility flag will be set to yes for each month that claims data is available for reporting) until an end date is determined for that patient, as described below.

Patients that are currently eligible, but are not on the interim attributed patient list, may be assigned an eligibility end date. In some embodiments, if the list is for the first measurement year, the eligibility end date will be the ACO start date. The desired functional outcome may be as if the patient was never eligible. The patient eligibility apparatus 102 may therefore set all the eligibility flags for the measurement year to no.

If the list is for a subsequent measurement year, the eligibility end date may be the last day of the ACO's prior measurement year. The patient may have no eligible months in the current measurement year. If the patient was not eligible in the prior measurement year, then the eligibility end date will be the first day of the ACO's current measurement year. The desired functional outcome may be as if the patient was never eligible. The patient eligibility apparatus 102 may therefore set all the eligibility flags for the measurement year to no.

It will be appreciated that operations 530 and 540, described above may be repeated, as additional interim attributed patient lists are received and processed by patient eligibility apparatus 102. As such, the patient eligibility apparatus 102 may use available data to calculate an accurate population-based report or risk rating at any time during the measurement year.

Continuing to operation 550, the patient eligibility apparatus 102 may receive a reconciled attributed patient list, such as on an annual basis, describing the patient population for a related measurement period, such as a calendar year. At operation 560, the patient eligibility apparatus 102 may update eligibility flags, start dates, and/or end dates based on the reconciled attributed patient list. Patients on the reconciled list may be considered eligible for the entire related measurement period. Assuming a measurement period of one calendar year, the proxy eligibility flags for all months in that calendar year may therefore be set to yes. Patients on the reconciled list that are currently eligible (based on the initial or a prior interim attributed patient list) for the related year may remain eligible for the full related measurement period and their eligibility flags for that measurement period may be permanently set to yes. Such patients may remain eligible until an eligibility end date may be determined based on a subsequent interim and/or reconciled patient list, due to the patient not being included on the list. An eligibility end date so established may relate to a measurement period subsequent to the measurement period in which the eligibility flags were permanently set to yes, as described above, in which case the patient may be eligible for the related measurement year, but not the subsequent measurement year. The patient eligibility apparatus 102 may update the proxy eligibility file, and/or proxy eligibility data accordingly.

In some embodiments, the patient eligibility apparatus 102 may update eligibility flags for patients that have eligibility for the related measurement period but are not on the reconciled attributed beneficiary list as follows. If a patient's eligibility start date is the first day of the related measurement period, their eligibility for the related measurement period will be removed for all months. The desired functional outcome may be as if the patient was never eligible. The patient eligibility apparatus 102 may therefore set all the eligibility flags for the measurement year to no.

Additionally or alternatively, for a patient eligible for the related measurement year but not on the reconciled attributed beneficiary list, the patient eligibility apparatus 102 may update eligibility flags as follows. If a patient's eligibility start date is a date during a year prior to the related measurement year, their eligibility end data will be set to the last date of the prior measurement year. The desired functional outcome in this scenario is that it may be as if the patient was never eligible for the related measurement year, but prior years of eligibility are retained. The patient eligibility apparatus 102 may therefore set eligibility flags for all months in the related measurement year, and all the months in the current measurement year, but not prior measurement year(s), to no.

At operation 570, the patient eligibility apparatus may generate a proxy eligibility file, based on any of the eligibility start dates, eligibility end dates, and/or eligibility flags described above. Additionally or alternatively, the proxy eligibility file may be generated in conjunction with operations 500-560. In some embodiments, the start dates, end dates, and/or flags may be stored as temporary data on memory 214, from which the proxy eligibility file may be generated from, on demand, and provided to a third party system such as provider organization system 108, or user terminal 110, for example. As such, eligible population based risk rates may be estimated, without the use of payer provided eligibility files, premium payment information, or the like.

FIGS. 3, 4 and 5 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a patient eligibility apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a patient eligibility apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

That which is claimed:

1. A method comprising:
receiving input data comprising at least one of a) claim data, or b) an attributed patient list; and
with a processor, generating proxy eligibility data based on the input data, wherein the proxy eligibility data comprises eligibility data by patient.

2. A method according to claim 1, wherein the proxy eligibility data comprises a patient identifier, an indication of a product, and a plurality of binary eligibility flags.

3. A method according to claim 2, wherein generating the proxy eligibility data further comprises:
for a patient, determining a value for at least one of the plurality of binary eligibility flags, wherein respective binary eligibility flags are associated with a predefined period of time;
receiving interim input data; and
updating the value of at least one binary eligibility flag retrospectively, based on the interim input data.

4. A method according to claim 1, wherein generating proxy eligibility data further comprises:
determining an eligibility start date for a patient based on the input data;
generating a proxy eligibility file comprising the eligibility start date; and
generating the proxy eligibility data based on the proxy eligibility file, wherein the proxy eligibility data is in a format compatible with a risk management application.

5. A method according to claim 1, wherein the proxy eligibility data is generated without the use of payer-provided eligibility data.

6. A method according to claim 1, wherein generating proxy eligibility data further comprises:
determining an eligibility start date for a patient based on the input data; and
generating the proxy eligibility data based on the eligibility start date.

7. A method according to claim 6, wherein generating proxy eligibility data further comprises:
determining an eligibility end date for the patient; and
generating the proxy eligibility data based on the eligibility end date.

8. A method according to claim 7, wherein determining the eligibility end date further comprises:
identifying a change in a product for a patient and an associated change date based on the input data; and
determining the eligibility end date based on the associated change date.

9. A method according to claim 1, further comprising:
receiving additional input data; and
retrospectively updating the proxy eligibility data based on the additional input data.

10. A method according to claim 1, further comprising:
calculating an eligible population based rate, based on the proxy eligibility data, wherein the eligible population based rate is used for calculating one or more metrics related to at least one of cost, utilization, or quality.

11. A method according to claim 1, further comprising:
calculating a fee associated with a claim; and
calculating an eligible population based rate based on at least the calculated fee and the proxy eligibility data.

12. A method according to claim 1, wherein receiving input data further comprises:
receiving outbound claim information from a provider organization.

13. A method according to claim 1, wherein receiving input data further comprises:
receiving claim information for in-network services from a payer.

14. A method according to claim 1, further comprising:
receiving pre-filtering criteria; and
identifying a subset of the input data based on the pre-filtering criteria, wherein the proxy eligibility data is generated based on the subset of the input data.

15. A method according to claim 1, wherein the input data comprises at least one attributed patient list for an Accountable Care Organization.

16. An apparatus comprising at least one processor and at least one memory including computer program code, the at least one memory and the computer program code configured to, with the processor, cause the apparatus to at least:
receive input data comprising at least one of: a) claim data, or b) an attributed patient list; and
generate proxy eligibility data based on the input data, wherein the proxy eligibility data comprises eligibility data by patient.

17. An apparatus according to claim 16, wherein the proxy eligibility data comprises a patient identifier, an indication of a product, and a plurality of binary eligibility flags.

18. An apparatus according to claim 17, wherein causing the apparatus to generate the proxy eligibility data further comprises:
for a patient, determining a value for at least one of the plurality of binary eligibility flags, wherein respective binary eligibility flags are associated with a predefined period of time;
receiving interim input data; and
updating the value of at least one binary eligibility flag retrospectively, based on the interim input data.

19. An apparatus according to claim 16, wherein causing the apparatus to generate proxy eligibility data further comprises:
determining an eligibility start date for a patient based on the input data;
generating a proxy eligibility file comprising the eligibility start date; and
generating the proxy eligibility data based on the proxy eligibility file, wherein the proxy eligibility data is in a format compatible with a risk management application.

20. A computer program product comprising at least one non-transitory computer-readable storage medium having computer-executable program code instructions stored therein, the computer-executable program code instructions comprising program code instructions to:
receive input data comprising at least one of: a) claim data, or b) an attributed patient list; and
generate proxy eligibility data based on the input data, wherein the proxy eligibility data comprises eligibility data by patient.

21. A computer program product according to claim 20, wherein the proxy eligibility data comprises a patient identifier, an indication of a product, and a plurality of binary eligibility flags.

22. A computer program product according to claim 21, wherein the computer-executable program code instructions comprising program code instructions to generate the proxy eligibility data further comprise program code instructions to:
for a patient, determine a value for at least one of the plurality of binary eligibility flags, wherein respective binary eligibility flags are associated with a predefined period of time;
receive interim input data; and
update the value of at least one binary eligibility flag retrospectively, based on the interim input data.

23. A computer program product according to claim 20, wherein causing the apparatus to generate proxy eligibility data further comprises:
determining an eligibility start date for a patient based on the input data;
generating a proxy eligibility file comprising the eligibility start date; and
generating the proxy eligibility data based on the proxy eligibility file, wherein the proxy eligibility data is in a format compatible with a risk management application.
